(19) United States
(12) Patent Application Publication
(10) Pub. No.: US 2002/0177981 A1
(43) Pub. Date: Nov. 28, 2002

(54) System and method for switchboard feeder design

(76) Inventors: Mark Joseph Fleming, Manchester, CT (US); Cyril Latrell Nesmith, Graham, NC (US)

Correspondence Address: CANTOR COLBURN, LLP, 55 GRIFFIN ROAD SOUTH, BLOOMFIELD, CT, 06002

(21) Appl. No.: 10/063,173

(22) Filed: Mar. 27, 2002

Related U.S. Application Data
(60) Provisional application No. 60/279,179, filed on Mar. 27, 2001.

(51) Int. Cl. G06F 17/50

(52) U.S. Cl. 703/1

(57) ABSTRACT

A method for configuring an individually mounted feeder section of a switchboard, the method comprising: initiating a utility for configuring a switchboard design; selecting a feeder device to be included in said switchboard design; entering a plurality of parameters for the feeder device in fields queried by the utility; checking existence of any individually mounted device; accessing a database for determining whether individually mounted feeder design is viable; retrieving a set of parameters for the individually mounted device, if any; and displaying output data corresponding to said selected feeder device and entered said plurality of parameters.

### CROSS REFERENCE TO RELATED APPLICATIONS

This application claims the benefit of Provisional Application No. 60/279,179, filed Mar. 27, 2001, the contents of which are incorporated herein by reference thereto.

### BACKGROUND OF INVENTION

A switchboard is an electrical power distribution component. Electrical power to a building flows from high voltage utility lines to step-down transformers, from the transformers to one or more switchboards, and from the switchboards to one or more branch or distribution circuits, which provide electrical power for lighting, heating and air conditioning, elevators, pumps, electrical outlets, and the like. Each switchboard includes one or more metal cabinets that are typically mounted as a freestanding unit on the floor of a utility room of a building.

A switchboard typically includes a utility portion, a main switching portion, and a feeder portion. Housed within the utility portion of the switchboard is the electrical connection apparatus for connecting a main power supply wire to a power supply bus within the switchboard. The utility portion of the switchboard also includes various meters for detecting various attributes of electrical power supplied to the switchboard. The power supply bus extends from the utility portion to the main switching portion. Housed within the main switching portion is a main switch, typically a circuit breaker, which stops the flow of electricity along the power supply bus. The power supply bus further extends from the main switching portion to the feeder portion. Housed within the feeder portion are one or more feeder devices that are attached to branch circuits. The one or more feeder devices provide an electrical connection between the power supply bus and one or more branch circuits. Such feeder devices include switches, circuit breakers, and the like. Also housed in the feeder portion are various meters for detecting various attributes of electrical power supplied to the branch circuits.

The utility, main switching, and feeder portions of a switchboard are housed in a plurality of cabinets. The feeder portion may be grouped or individual. That is, the feeder portion may include a number of feeder devices mounted as a group in a single cabinet (group mounted) or the feeder portion may include only one feeder device mounted in a single cabinet (individually mounted). Typically, individually mounted feeder devices are required where the amperage rating of the branch circuit is greater than about 1200 amps. In switchboards servicing both high and low amperage branch circuits, the switchboard may be designed to have both an individually mounted feeder device, in one cabinet and group mounted feeder devices in an adjacent cabinet. Accordingly, the design of the switchboard depends greatly on the number of branch circuits, the amperage ratings of the branch circuits, and the electrical devices (e.g., main switch, feeder devices, and meters) that are required by the customer.

As can be appreciated, it would be advantageous to automate the design of the above mentioned switchboards. This has been done up to a point with General Electric Company's commercially available Speedi-WIN™ software program. Speedi-WIN™ is a personal computer-based software program consisting of millions of lines of code in Visual Basic, Clipper, C, and COBOL.

Using an automatic switchboard design system such as General Electric Company's Speedi-WIN™ system, the design of a switchboard would proceed as follows: a customer would provide a sales engineer with a written or verbal description of the specifications that the switchboard must meet; the sales engineer would enter the customer's specifications into the automatic switchboard design system; output from the automatic switchboard design system, which includes drawings and material specification sheets, would be provided to a requisition (order) engineer; the requisition engineer would oversee the manufacture of the switchboard and provide the resulting product to the customer.

However, automatic switchboard design systems of the prior art are not configured to design individually mounted feeder devices. In cases where the customer's order involves an individually mounted feeder device, the above-described procedure must be altered to compensate for this limitation. Typically, the sales engineer must design the switchboard to the best extent possible using the automatic switchboard design system, and then compensate for the system limitation by instructing the requisition engineer, either verbally or by writing, to modify the output of the automatic switchboard design to include the individually mounted feeder device. Because manual intervention is required to modify the output of the automatic switchboard design system, the pricing and design of the switchboard are subject to human error, and the sales engineer cannot get a “true” drawing of the single switchboard. Moreover, if the verbal or written communications made by the sales engineer are lost or forgotten, the switchboard could be manufactured to the unmodified, and incorrect, output of the automatic switchboard design system, causing delivery dates to be missed and costly rebuilding of the switchboard.

### SUMMARY OF INVENTION

The above discussed and other drawbacks and deficiencies are overcome or alleviated by a method for configuring an individually mounted feeder section of a switchboard, the method comprising: initiating a utility for configuring a switchboard design; selecting a feeder device to be included in said switchboard design; entering a plurality of parameters for the feeder device in fields queried by the utility; checking existence of individually mounted devices; retrieving a set of parameters for each of the individually mounted devices; and displaying output data corresponding to said selected feeder device and entered said plurality of parameters.

### BRIEF DESCRIPTION OF DRAWINGS

Referring to the exemplary drawings wherein like elements are numbered alike in the several FIGURES:

FIG. 1 shows an exemplary environment in which switchboard design software may be implemented;

FIG. 2 is a schematic diagram illustrating a series of dialog screens provided by the switchboard design software;

FIG. 3 shows a Switchboard data input dialog screen provided by the switchboard design software;

FIG. 4 shows a General data input dialog screen provided by the switchboard design software;

FIG. 5 shows a Bus and Access data input dialog screen provided by the switchboard design software;

FIG. 6 shows a Utility and Metering data input dialog screen provided by the switchboard design software;

FIG. 7 shows a Main data input dialog screen provided by the switchboard design software;

FIG. 8 shows a Feeder data input dialog screen provided by the switchboard design software;

FIG. 9 shows an Options data input dialog screen provided by the switchboard design software;

FIG. 10 is a description of an individually mounted device database table;

FIG. 11 is a description of a database table for determining the width, depth, and mounting for a given individually mounted feeder device;

FIG. 12 is a description of a database table for determining the location of an individually mounted feeder device within a switchboard;

FIG. 13 is a description of a database table for determining the Conduit icons for generating the drawing of the switchboard;

FIG. 14 is a description of a database table for determining the icons for the devises, covers, doors, and filler plates to be used in the drawing of the switchboard;

FIG. 15 is a description of a database table for determining the icons for the Neutral/Ground information on the drawing of the switchboard; and

FIG. 16 is a drawing generated by the switchboard design software.

### DETAILED DESCRIPTION

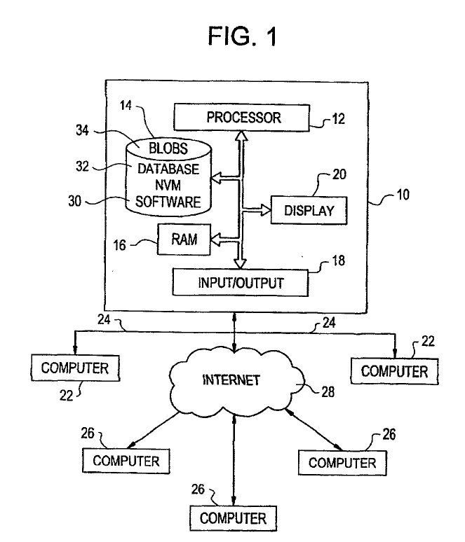

FIG. 1 shows a general purpose computer 10 having a processor 12 in communication with a non-volatile memory (NVM) 14, random access memory 16, input/output means 18 and a display 20. Non-volatile memory (NVM) 14 may be a computer disk or other machine-readable media suitable for storing computer programs, data, and the like. Random access memory 16 temporarily stores data or computer programs for manipulation by the processor 12 and for faster retrieval than would be possible from non-volatile memory 14. Input/output means 18 may include such things as a keyboard and a mouse for local input, or a network connection allowing for communications with other computers. For instance, computer 10 is in communication with computers 22 via connections 24, which optionally includes a local area network (LAN). Computer 10 is also in communication with computers 26 via Internet 28.

A switchboard design software program 30 that may be run on computers 10 or 22 for use by a user at that computer resides in file storage in NVM 14 and is executed by processor 12. Software program 30 may be written using any programming language. For example, software program 30 may be written using Visual Basic, Clipper, C, and COBOL. In addition, the switchboard design software program 30 may be configured as web-enabled software, such as a web applet. In this case, program 30 may be stored in NVM 14 and run on processor 12 of computer 10 and may be interacted with from computers 22 on network 24 or from computers 26 via Internet 28.

Switchboard design software program 30 instructs processor 12 to perform a number of steps necessary to allow the user to design a switchboard with an individually mounted feeder device. As a matter of convention, it is typically stated that a program “performs” these steps, even though one skilled in the art would recognize that the program is executed by a processor, and that a processor or other device controller physically performs these tasks. This convention will be adhered to hereinafter, with one skilled in the art recognizing that program 30 instructs processor 12 to perform the functions attributed to program 30.

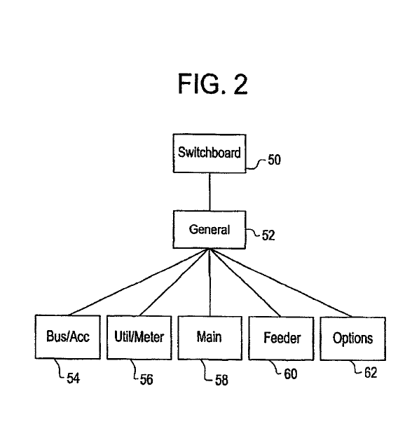

Turning now to FIGS. 1 and 2, a diagram illustrating the hierarchy of data input dialog screens 50, 52, 54, 56, 58, 60, and 62 is shown. Data input dialog screens 50, 52, 54, 56, 58, 60, and 62 are displayed on display 20 in response to execution of a data input portion of switchboard design software 30. In one embodiment, the data input portion of switchboard design software 30 is written in the Visual Basic programming language. It will be recognized, however, that other programming languages may also be used. Each of the data input dialog screens 50, 52, 54, 56, 58, 60, and 62 permit the user to select from electrical components available for different portions of the switchboard. In FIG. 2, the data input dialog screens are arranged in a hierarchy indicating the order in which the data input portion of switchboard design software 30 causes the data input dialog screens to be presented to the user.

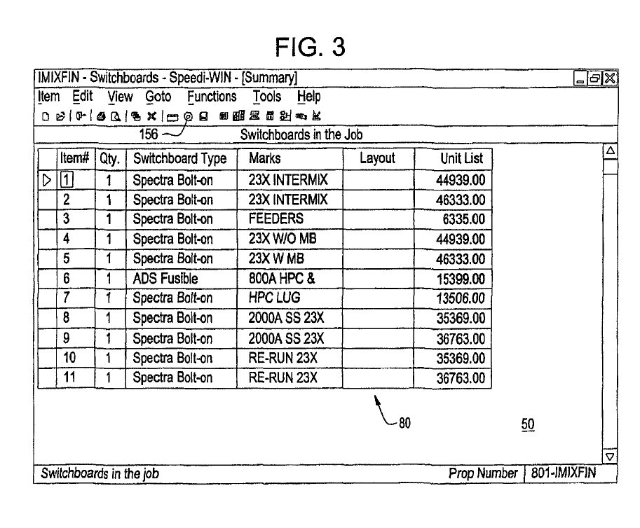

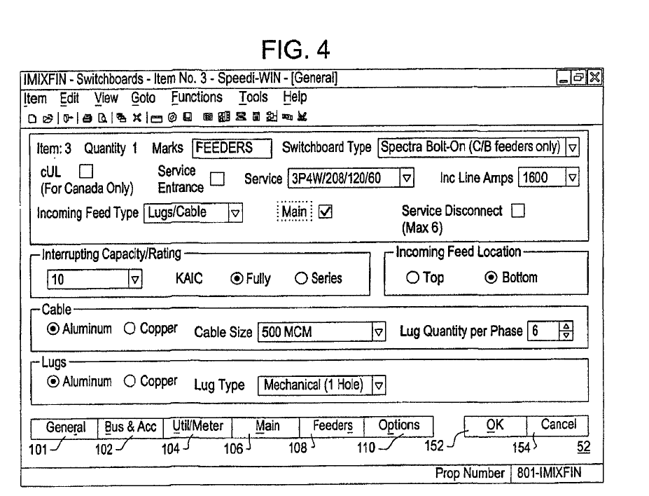

When the user first initiates the switchboard design software program 30, a switchboard screen 50 is displayed on display 20. FIG. 3 depicts switchboard screen 50. As shown in FIG. 3, the user is presented with a list of switchboard items that have already been entered in the system 80. The user selects one of the switchboard items to edit or enters a new switchboard item 80 by selecting the appropriate command from the menu located at the top of the dialog screen. In response to the user's selection, program 30 queries a database 32 in NVM 14 for data on the selected switchboard item or returns default data for a new switchboard item. After the data has been retrieved, the program 30 causes a general dialog screen 52, as shown in FIG. 4, to be displayed on display 20, with the appropriate data from the selected switchboard section entered in the various fields of the general dialog screen 52. Using data input fields in the general dialog screen 52, the user specifies general parameters for the switchboard section such as the electrical service (e.g., number of phases, rated voltage, and cycles) to be handled by the switchboard section, the incoming line amperage, the interrupting capacity of the switchboard section, the type and size of the cable that is to be fed into the switchboard and the lug type that is to accept the cable. The “Switchboard Type” field is a drop down list including the various types of switchboards available to the user. When a user selects one of the switchboard types in the “Switchboard Type” field, program 30 queries database 32 to determine default data for that particular switchboard type. Program 30 then populates the various data input fields in data input dialog screens 52, 54, 56, 58, 60, and 62, with the default data. Located at the bottom of each dialog screen 52, 54, 56, 58, 60, and 62 are a number of buttons 101,102, 104, 106, 108, and 110. Each title shown on the buttons 101, 102, 104, 106, 108, and 110 represents dialog screens 52, 54, 56, 58, 60, and 62, allowing the user to navigate between the screens 52, 54, 56, 58, 60, and 62.

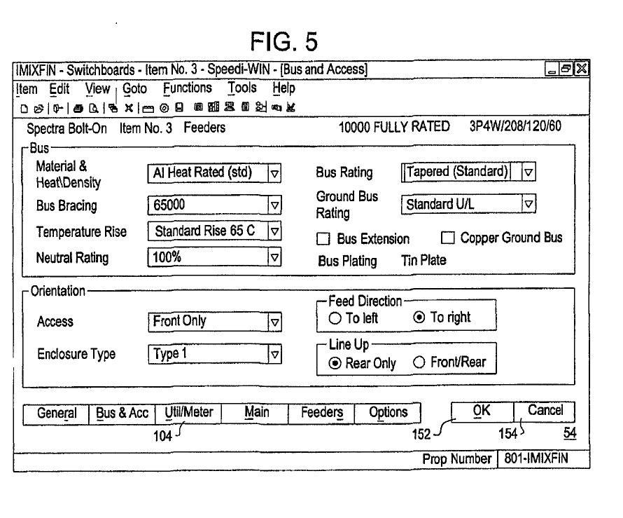

After the data has been entered into the data input fields of the general dialog screen 52, the user selects the “Bus & Acc” button 102. In response, program 30 causes a Bus and Access dialog screen 54, as shown in FIG. 5, to appear on display 20 with default data corresponding to the switchboard type and other inputs selected in dialog screen 52 entered in the appropriate fields of dialog screen 54. Using data input fields in dialog screen 54, the user enters design specifications for the bus bar that is to be installed in the switchboard. Such design specifications include: the construction material, the bus rating, the bus bracing, the design temperature rise, the neutral rating, and the orientation of the bus bar in the switchboard section.

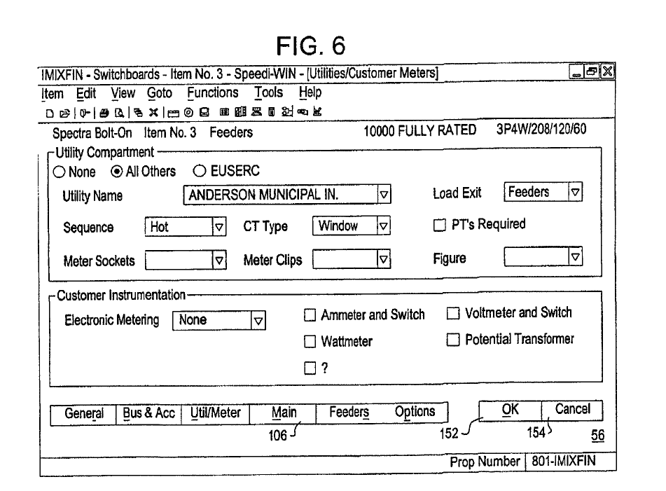

After the data has been entered into the data input fields of the bus and access dialog screen 54, the user selects the “Util/Meter” button 104. In response, program 30 causes a Utility/Customer Meters dialog screen 56, as shown in FIG. 6, to appear on display 20 with default data corresponding to the switchboard selections in dialog screen 52 entered in the appropriate fields of dialog screen 56. Using data input fields in dialog screen 56, the user enters design specifications for the utility portion of the switchboard. Such specifications include: whether or not a utility portion is to be installed, the load type at the exit of the utility portion, the current transformer type to be installed, and the types of electronic meters (if any) that are to be installed in the switchboard section.

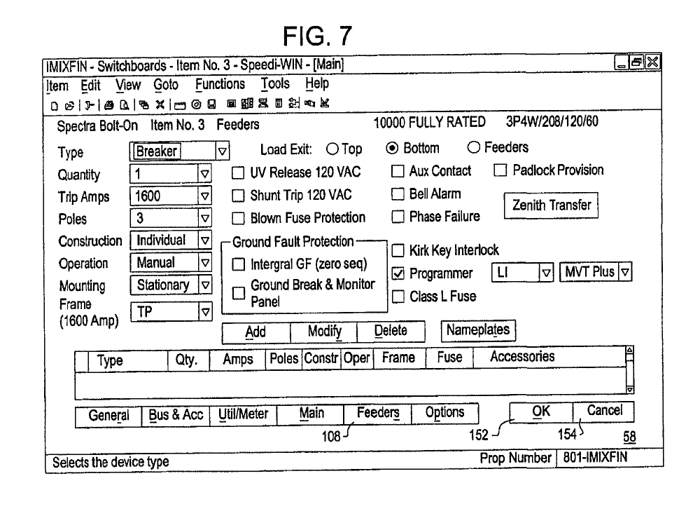

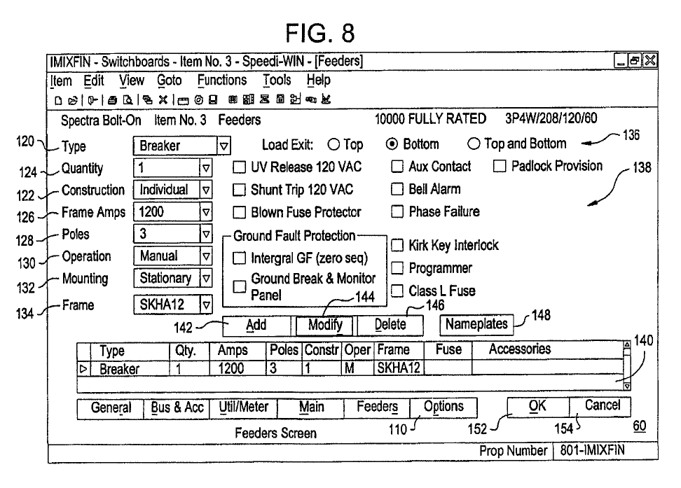

After the data has been entered into the data input fields of the Utility/Customer Meters dialog screen 56, the user selects the “Main” button 106. In response, program 30 causes a Main dialog screen 58, as shown in FIG. 7, to appear on display 20 with default data corresponding to the switchboard selections in dialog screen 52 entered in the appropriate fields of dialog screen 58. Using data input fields in dialog screen 58, the user enters design specifications for the main switching portion of the switchboard. Such design specifications include: the type of main switching device to be installed, the amperes at which the device will trip, the type of operation (manual or electric), and other options available for the main switching device.

After the data has been entered into the data input fields of the Main dialog screen 58, the user selects the “Feeder” button 108. In response, program 30 causes a Feeder dialog screen 60 to appear on display 16 with data corresponding to the switchboard selections in dialog screen 52 entered in the appropriate fields of dialog screen 60. Using data input fields in dialog screen 60, the user enters design specifications for one or more feeder devices to be installed in the one or more feeder portions of the switchboard.

Dialog screen 60 includes a “Type” field 120 from which the user selects a type of feeder device to be installed in the switchboard. “Type” field 60 is a drop down list box that allows the user to select the feeder device type by clicking on (selecting) an arrow to the right of field 60 to reveal a list of feeder device types available for the type of switchboard previously selected in dialog screen 52. The user then clicks on (selects) one of the feeder device types listed in the drop-down list. Once the user has selected a feeder device type, program 30 populates the remaining fields in dialog screen 60 with default values associated with the selected feeder device. The default values for each feeder device are retrieved from database 32.

A “Constuction” field 122 allows the user to specify whether the selected feeder device is individually mounted or group mounted. Similar to “Type” field 120, “Construction” field 122 is a drop down list box. If a type of feeder device, as selected in “Type” field 120, is not available either as individually or group mounted, the “Construction” field 122 will indicate this by preventing a user from selecting the unavailable option.

Where the feeder device is available as an individually mounted feeder, and the individually mounted feeder option is selected in field 122, program 30 queries a table in a database 32 to determine the various frame types available for that individually mounted feeder. A frame type describes an individual category of devices.

A “Quantity” field 124 accepts a numerical quantity of the type of feeder device selected in field 120. Dialog screen 60 also includes “Frame Amps”, “Poles”, “Operation”, “Mounting”, and “Frame” fields 126, 128, 130, 132, and 134, which are all drop down list boxes. “Frame Amps” field 126 allows the user to select the rated amperage of the feeder device, and “Poles” field 128 allows the user to select the number of phases in the supply wiring to the feeder device. “Operation” field 130 allows the user to select whether the feeder device is to be manually or electrically operated. “Mounting” field 132 allows the user to select whether the feeder device is to be stationary or draw-out, and “Frame” field 134 indicates the frame of the feeder device. Like the “Construction” field 122, fields 126, 128, 130, 132, and 134 are drop down lists that allow the user to select from available options for the particular switchboard selections in dialog screen 52, and for the particular type of feeder device selected in “Type” field 120. Also like the “Construction” field 122, program 30 prevents the user from selecting an option unavailable for the particular switchboard and feeder device types.

Where an individually mounted feeder has been selected in field 122, “Frame” field 134 includes only those frame types available for the individually mounted feeder type indicated in field 120, as determined in the above mentioned query of the table in database 32. Because the user is only allowed to choose valid frame types in field 134, further design validation for the feeder portion of the switchboard is not necessary, as it was with the prior art. In other words, it is no longer necessary to manually ensure that a valid frame type has been selected for the individually mounted device. As a result, engineering time is reduced from that previously possible with prior art switchboard design software.

To the right of the “Type” field 120 are check boxes 136 for selecting a “Load Exit” option (i.e., top, bottom, or both) to indicate the location that the load wiring is to exit the feeder device. Below the “Load Exit” option check boxes 136 are checkboxes 138 that may be selected to add further options and accessories associated to the feeder device. Such options include ground fault protection, trip actuation method, monitoring options, locking options, etc. If a particular option is not available for the type of feeder device selected in field 120, then program 30 prevents the user from selecting the check box 136 or 138 associated with that option. As shown in Dialog screen 60, the unavailable options appear to be light gray in color, as opposed to the black color of available options.

Beneath the “Frame” field 134 is a list 140 of feeder devices that have been added by the user (if any). The items listed in list 140 correspond to the data accepted in fields 120, 122, 124, 126, 128, 130, 132, and 134 and any options/accessories selected in check boxes 136 and 138 for each feeder device added by the user. Above list 140, four buttons 142, 144, 146, and 148, which are optionally selected for either adding a feeder device to list 140, modifying a feeder device in list 140, deleting a feeder device from list 140, or to inputting text to appear on a nameplate of the feeder device in list 140.

For example, after the user enters specification data for the feeder portion in dialog screen 60, the user selects the “Add” button 142. In response, program 30 causes the specification data for that feeder device to be stored in NVM 14. Program 30 then causes dialog screen 60, to be updated to include the feeder device in list 140. If the user requires more than one feeder device, then additional feeder devices can be added by entering specification data for the additional feeder device into the data input fields of dialog screen 60 and then selecting the “Add” button 142. After a feeder device has been added to list 140, specification data for that feeder device can be edited by highlighting the instance of the feeder section in list 140 and selecting the “Modify” button 144. In response, program 30 will cause the specification data for the desired feeder device to appear in dialog screen 60 where the data can be edited. A feeder device can be removed from list 140 by highlighting the instance of the feeder section in list 140 and then selecting the “Delete” button 146. In response, program 30 will cause the specification data for that feeder device to be deleted from NVM 14, and then will cause the instance of the feeder device to be removed from dialog screen 140.

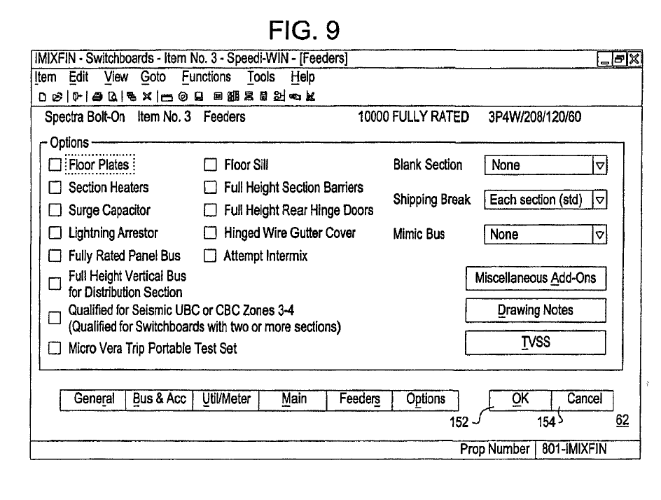

After the data has been entered into the data input fields of the Feeder dialog screen 60, the user selects the “Options” button 110. In response, program 30 causes an Options dialog screen 62, as shown in FIG. 9, to appear on display 20 with default data corresponding to the switchboard selection in dialog screen 52 entered in the appropriate fields of dialog screen 62. Using data input fields and check boxes in dialog screen 62, the user enters additional options for the switchboard section.

Located at the bottom of each dialog screen 52, 54, 56, 58, 60, and 62 are “OK”/“Finish” and “Cancel” buttons 152 and 154. If the user selects the “OK”/“Finish” button 152, program 30 writes the specification data entered in that dialog screen 52, 54, 56, 58, 60, or 62 to one or more binary large objects (BLOBs) 34 in NVM 14, and closes the dialog screen from display 20. If the user selects the “Cancel” button 154, program 30 ignores the configuration data entered in that dialog screen 52, 54, 56, 58, 60, or 62 and closes the dialog screen from display 20.

Also in response to the selection of “OK” button 152, program 30 causes a number of data input verification checks to be made. For example, if a user has entered only one feeder device in list 140 of dialog screen 60, and that one feeder device is an individual feeder, program 30 will cause an error message to appear on display 20. This check is performed because, if a switchboard is to serve only a single branch circuit, then a feeder portion is not used. Rather, the single branch circuit would be connected directly to the main switching portion of the switchboard. The error message will instruct the user on how to correct the error.

After the user inputs data into each of the dialog screens 52, 54, 56, 58, 60, and 62, the user initiates an engineering subroutine in program 30 by selecting an icon 156 at the top of dialog screen 50. In one embodiment, the engineering subroutine of switchboard design software 30 is written in the C programming language. It will be recognized, however, that other programming languages may also be used.

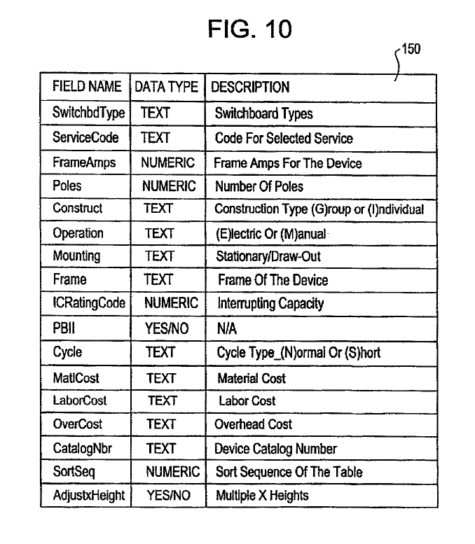

The engineering subroutine retrieves the data from the one or more BLOBs 34 and adds the data to appropriate fields in one or more data input tables within database 32. A portion of a data input table 150 in database 32 is shown in FIG. 10.

The portion of data input table 150 shown in FIG. 10 includes a number of named fields for storing data of a particular data type. FIG. 10 also shows a description of each field. Within data input table 150, the following fields contain user data input in a corresponding data input field in dialog screen 52: “SwitchbdType”, “ServiceCode”, “FrameAmps”, and “ICRatingCode”. Within table 150, the following fields indicate user data input in a corresponding data input field in dialog screen 58: “Poles”, “Construct”, “Operation”, “Mounting”, and “Frame”. For example, the “SwitchbdType” field stores a text data type, which indicates the type of switchboard selected by the user in dialog screen 52. The “Construct” field stores a text data type that describes whether the construction of the feeder device is group or individual, as selected by the user in dialog screen 58. The “Frame” field stores a text data type that describes the frame type needed for the specified switchboard type and construction type, as entered in dialog screen 58.

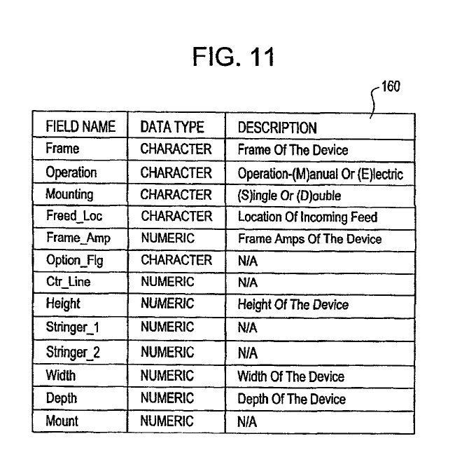

After the engineering subroutine populates the fields of the data input tables 150 with data from BLOBs 34, the engineering subroutine then completes the switchboard design by querying a number of tables in database 32 to determine additional design data. Examples of the tables queried by the engineering subroutine in the design of an individually mounted feeder device are shown in FIGS. 11 through 15.

FIG. 11 is a description of a database table 160 for determining the width, depth, and mounting for a given individually mounted feeder device. In table 160, five key fields (“Frame”, “Operation”, “Mounting”, “Feed_Loc”, and “Frame_Amp”) are used to determine a width, depth, and mounting corresponding to those key fields. Engineering subroutine reads data from the one or more data input tables 150 and searches through the data in key fields of table 160 until a match is found. After a match is found, engineering subroutine reads the corresponding “Width”, “Depth”, and “Mount” fields, and stores this data in the one or more data input tables 150. Using this dimension data, the engineering subroutine will determine the dimensions of each switchboard section and will set the bussing and wiring specifications for each section. This data will also be stored in the one or more data input tables 150.

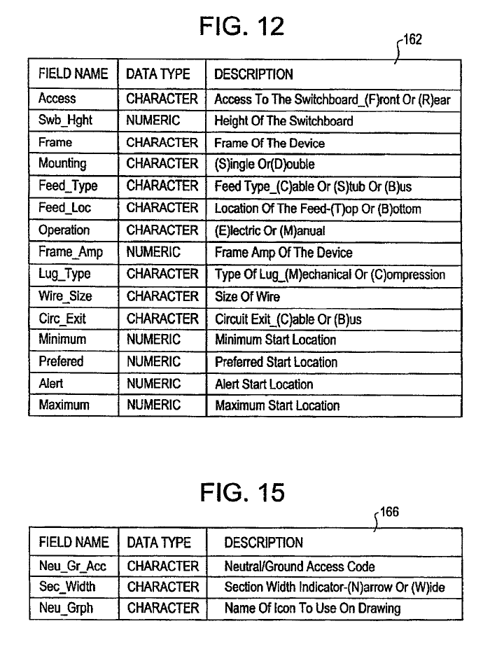

FIG. 12 is a description of a database table 162 for determining locations of an individually mounted feeder devices within a switchboard. In table 162, eleven key fields (“Access”, “Swb_Hght”, “Frame”, “Mounting”, “Feed_Type”, “Feed_Loc”, “Operation”, “Frame_Amp”, “Lug_Type”, “Wire_Size”, and “Circ_Exit”) are used to determine a range of locations in which the device may be placed (“Minimum”, “Preferred”, “Alert”, and “Maximum”). Engineering subroutine reads data from the one or more data input tables 150 and searches through the data in key fields of table 162 until a match is found. After a match is found, engineering subroutine reads the corresponding “Minimum”, “Preferred”, “Alert”, and “Maximum” fields, and stores this data in the one or more data input tables 150.

Table 162 contains the valid placement locations and dimensions for all individually mounted devices. The engineering subroutine will use this placement data to determine valid locations for the individually mounted device within each section of the switchboard design. For example, the engineering subroutine will position individually mounted sections after the main section and before any group mounted feeder sections in descending amperage order. If more than one valid location is available, then the engineering subroutine will choose a default location. The engineering subroutine will add cabinets to the switchboard design as is necessary to locate all of the devices within the switchboard. Location data for each device in the switchboard is stored in the one or more data input tables 150.

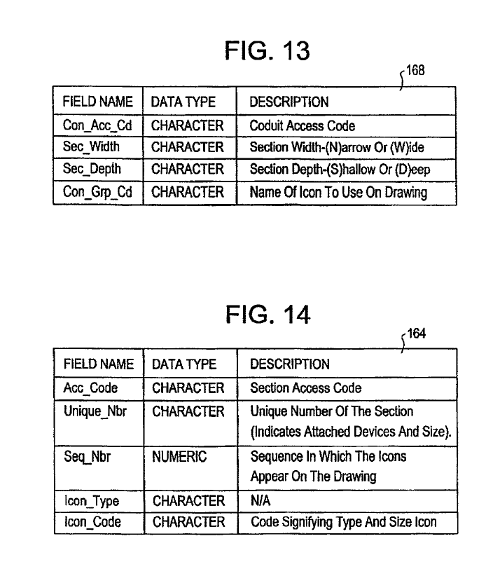

FIG. 13 is a description of a database table 168 for determining Conduit icons for generating a drawing of the switchboard. In table 168, three key fields (“Con_Acc_Cd”, “Sec_Width”, and “Sec_Depth”) are used to determine an icon name (“Con_Grp_Cd”) corresponding to those key fields. The Con_Acc_Cd field includes an access code that identifies a section. Engineering subroutine reads data from the one or more data input tables 150 and searches through the data in key fields of table 168 until a match is found. After a match is found, engineering subroutine reads the corresponding “Con_Grp_Cd” field, and stores this data in the one or more data input tables 150.

FIG. 14 is a description of a database table 164 for determining the icons for devices, covers, doors, and filler plates to be used in the drawing of the switchboard. In table 164, two key fields (“Acc_Code”, and “Unique_Nbr”) are used to determine a code signifying an icon type and size (“Icon_Code”) corresponding to those key fields. The Acc_Code field includes an access code that identifies a section. The engineering subroutine determines the access code from data in the one or more data input tables 150. The Unique_Nbr field includes a number that uniquely identifies the component and size. The engineering subroutine generates a unique number from data in the one or more data input tables 150. For example a unique number of 124/32 for a main section would be broken down as: the number 124 indicates 1 component in the section being placed at 24 inches down from the top of the section; the number 32 indicates that the main is 32 inches in height. After determining the access code and unique number corresponding to the data in the one or more data input tables 150, the engineering subroutine searches through the data in key fields of table 164 until a match is found. After a match is found, engineering subroutine reads the corresponding “Icon_Code” field, and stores this data in the one or more data input tables 150.

FIG. 15 is a description of a database table 166 for determining icons for the Neutral/Ground information on the drawing of the switchboard. In table 168, two key fields (“Neu_Gr_Acc”, and “Sec_Width”) are used to determine an icon name (“Neu_Grph”) corresponding to those key fields. The Neu_{—Gr}_Acc field includes an access code that identifies a section. Engineering subroutine reads data from the one or more data input tables 150 and searches through the data in key fields of table 166 until a match is found. After a match is found, engineering subroutine reads the corresponding “Neu_Grph” field, and stores this data in the one or more data input tables 150.

After all of the fields in the one or more data input tables 150 have been populated, the engineering subroutine stores the data from the one or more data input tables into BLOBs 34, and the engineering subroutine ends.

After the engineering subroutine ends, the user can print a drawing of the switchboard by selecting the “Print” function from a menu at the top of data input dialog screen 50. This action initiates a drawing subroutine in switchboard design software program 30. In one embodiment, the drawing subroutine of switchboard design software 30 is written in the C programming language. It will be recognized, however, that other programming languages may also be used.

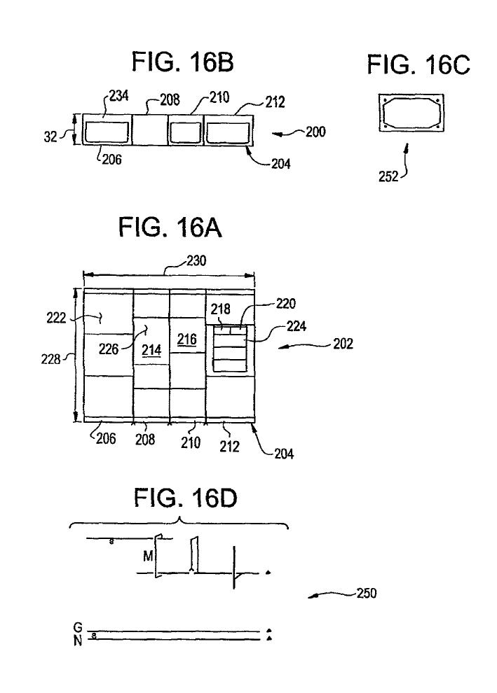

The drawing subroutine retrieves the data from the one or more BLOBs 34 and adds the data to appropriate fields in one or more data input tables 150 within database 32. The drawing subroutine then retrieves size and location data and icon codes from the one or more data input tables 150. Next, the drawing subroutine retrieves the appropriate icons (e.g., binary images) from NVM 14, and arranges the icons according to the size and location data. The arranged icons are provided as a script file to a commercially-available drafting program, such as EasyCad, which provides the switchboard drawing to an output device such as a printer, or display 20. An example of a drawing generated by the drawing subroutine is shown in FIG. 16.

As can be seen in FIG. 16, the drawing includes a plan view 200 and a front view 202 of a switchboard cabinet assembly 204 including a utility section 206, a main section 208, an individually mounted feeder section 210, and a group mounted feeder section 212. The main section 208 includes a main device 214. Individually mounted feeder section 210 includes an individually mounted feeder device 216, and group mounted feeder section 212 includes feeder devices 218 and 220. Each section includes panel covers 222 and filler plates 224 or doors 226, which cover openings in the switchboard cabinet assembly 204. Plan and Front views 200 and 202 also show height, width, and depth dimensions 228, 230, and 232, respectively, for each section. Plan view 200 includes an internal spacing dimension 234. The drawing generated by drawing subroutine also includes a bussing diagram 250 and a conduit space diagram 252.

Switchboard design software program 30 automates the design of electrical switchboards including individually mounted feeder devices. Accordingly, switchboard design software program 30 alleviates the deficiencies of prior art switchboard design software, which require manual intervention to modify the output of the automatic switchboard design system. Because switchboard design software program 30 no longer requires manual intervention, the switchboard design software program 30 allows a user to get a true drawing of a switchboard including an individually mounted feeder. In addition, the switchboard design software program 30 eliminates the potential for error associated with manual intervention in the design process.

The present disclosure can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present disclosure can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for configuring an individually mounted feeder section of a switchboard, the method comprising:
initiating a utility for configuring a switchboard design;
selecting a feeder device to be included in said switchboard design;
entering a plurality of parameters for said feeder device in fields queried by said utility;
checking existence of individually mounted devices, including a main and a utility compartment;
retrieving a set of parameters for each of said individually mounted devices; and
displaying output data corresponding to said selected feeder device subject to parameter limitations.

2. The method of claim 1 wherein said checking existence includes determining existence on any group mounted device, including any feeders, for determining whether an individually mounted feeder design will be attempted.

3. The method of claim 1 wherein said output data is displayed on an output screen.

4. The method of claim 1 wherein said output data comprises a generated drawing of said individually mounted feeder design.

5. The method of claim 3 wherein said plurality of parameters is entered by selecting from a drop-down list in said output screen.

6. The method of claim 1 wherein each of said individually mounted devices is disposed in an individual section.

7. he method of claim 6 wherein said each of said individually mounted devices is disposed in descending amperage order.

5 The method of claim 1 wherein each of said individually mounted devices is disposed intermediate a main device and any group mounted device.

9. The method of claim 1 further comprising:
creating a table having said set of parameters for said individually mounted feeder design.

10. The method of claim 1 further comprising:
changing said set parameters into a new set of parameters based upon a predetermined requirement.

11. A storage medium encoded with machine-readable computer program code for defining an individually mounted feeder section wherein an electric power flowing into the individually mounted feeder section first flows through a main section, the storage medium including instructions for causing a computer to implement a method comprising:
initiating a utility for configuring a switchboard design;
selecting a feeder device to be included in said switchboard design;
entering a plurality of parameters for said feeder device in fields queried by said utility;
checking existence of individually mounted devices, including a main and a utility compartment;
retrieving a set of parameters for each of said individually mounted devices; and
displaying output data corresponding to said selected feeder device subject to parameter limitations.

12. The storage medium of claim 11 wherein said checking existence includes determining existence on any group mounted device, including any feeders, for determining whether an individually mounted feeder design will be attempted.

13. The storage medium of claim 11 wherein said output data is displayed on an output screen.

14. The storage medium of claim 13 wherein said output data comprises a generated drawing of said individually mounted feeder design.

15. The storage medium of claim 11 wherein said plurality of parameters is entered by selecting from a drop-down list in said output screen.

16. The storage medium of claim 11 wherein each of said individually mounted devices is disposed in an individual section.

17. The storage medium of claim 16 wherein said each of said individually mounted devices is disposed in descending amperage order.

18. The storage medium of claim 11 wherein each of said individually mounted devices is disposed intermediate a main device and any group mounted device.

19. The storage medium of claim 11 further comprising:
creating a table having said set of parameters for said individually mounted feeder design.

20. The storage medium of claim 11 further comprising:
changing said set parameters into a new set of parameters based upon a predetermined requirement.

21. A system for configuring an individually mounted feeder section for a switchboard wherein electric power flowing into said switchboard is distributed to the individually mounted feeder section, the system comprising:
a computer having a central processor, a memory, an input means, and a display, said memory including executable code for;
initiating a utility for configuring a switchboard design;
selecting a feeder device to be included in said switchboard design;
entering a plurality of parameters for said feeder device in fields queried by said utility;
checking existence of any individually mounted device, including a main and a utility compartment;
accessing a database for determining whether an individually mounted feeder design is viable;
retrieving a set of parameters for said any individually mounted device; and
displaying output data corresponding to said selected feeder device and entered said plurality of parameters subject to parameter limitations.

22. The system of claim 21 wherein said checking existence includes determining existence on any group mounted device, including any feeders, for determining whether an individually mounted feeder design will be attempted.

20. The system of claim 21 wherein said output data is displayed on an output screen.

24. The system of claim 21 wherein said output data comprises a generated drawing of said individually mounted feeder design.

25. The system of claim 23 wherein said plurality of parameters is entered by selecting from a drop-down list in said output screen.

26. The system of claim 21 wherein each of said individually mounted devices is disposed in an individual section.

27. The system of claim 26 wherein said each of said individually mounted devices is disposed in descending amperage order.

28. The system of claim 21 wherein each of said individually mounted devices is disposed intermediate a main device and any group mounted device.

29. The system of claim 21 further comprising:
creating a table having said set of parameters for said individually mounted feeder design.

30. The system of claim 21 further comprising:
changing said set parameters into a new set of parameters based upon a predetermined requirement.
